(19) United States
(12) Patent Application Publication
(10) Pub. No.: US 2016/0066267 A1
(43) Pub. Date: Mar. 3, 2016

(54) POWER ADAPTATION DURING COMMUNICATION FOR IMPROVED MARGIN

(71) Applicant: Apple Inc., Cupertino, CA (US)

(72) Inventors: Mohit Narang, San Jose, CA (US); Peter M. Agboh, San Francisco, CA (US); Vusthla Sunil Reddy, San Jose, CA (US); Chia Yiaw Chong, San Jose, CA (US); Indranil S. Sen, Fremont, CA (US); Ruben Caballero, San Jose, CA (US); Manjit S. Walia, San Jose, CA (US); Xi Yang, Cupertino, CA (US)

(21) Appl. No.: 14/474,718

(22) Filed: Sep. 2, 2014

(51) Int. Cl. H04W 52/02; H04W 4/00

(52) U.S. Cl. CPC H04W 52/0209; H04W 4/008

(57) ABSTRACT

In order to improve communication with another electronic device, during an advertising mode an electronic device (such as a smartphone) may transmit a packet with advertising information using a default transmit power level. Then, based on feedback about a performance metric associated with the communication from the other electronic device, the electronic device may selectively increase the transmit power level for a subsequent packet. Because this selective increase in the transmit power level may increase the overall power consumption, the change in the transmit power level may depend on a battery power level of the electronic device. However, the selective increase in the transmit power level may decrease the overall power consumption by reducing or eliminating retries.

### BACKGROUND

1. Field

The described embodiments relate to techniques for improving the communication quality of an electronic device.

2. Related Art

Many modern electronic devices include a networking subsystem that is used to wirelessly communicate with other electronic devices. For example, these electronic devices can include a networking subsystem with a cellular network interface (UMTS, LTE, etc.), a wireless local area network interface (e.g., a wireless network such as described in the Institute of Electrical and Electronics Engineers (IEEE) 802.11 standard or Bluetooth™ from the Bluetooth Special Interest Group of Kirkland, Wash.), and/or another type of wireless interface.

In many wireless-communication protocols, electronic devices detect each other by regularly transmit advertising packets and scanning for advertising packets from other electronic devices. For example, an electronic device may communicate such advertising packets using a communication protocol that is compatible with a Bluetooth standard, such as Bluetooth Low Energy (BTLE).

However, the communication of advertising packets in communication protocols such as BTLE is often limited by power constraints in portable electronic devices. This can degrade the performance of the communication with the other electronic devices, which can degrade the user experience.

### SUMMARY

The described embodiments include an electronic device. This electronic device includes: an antenna; and an interface circuit, coupled to the antenna, which communicates with another electronic device using a communication protocol. During operation, the interface circuit: transmits a packet to the other electronic device during an advertising mode using a first transmit power level; receives feedback from the other electronic device about the communication, where the feedback includes information specifying a performance metric associated with the communication; and selects a transmit power level used to transmit a subsequent packet based on a power-state flag. Moreover, the electronic device includes a processor and memory that stores a program module. During operation, the processor executes the program module to improve communication quality. In particular, the program module compares the performance metric to a threshold value; and selectively modifies the power-state flag based on the comparison, where the modification changes the power-state flag from a value associated with a low-power state to a value associated with a high-power state, and where a second transmit power level in the high-power state is larger than the first transmit power level in the low-power state.

Note that the performance metric includes: a bit error rate, a packet error rate, a received signal strength indicator, and/or another link quality metric.

Moreover, the selective modifying may be based on a battery power level.

Furthermore, a difference between the second transmit power level and the first transmit power level may be fixed. Alternatively, the difference between the second transmit power level and the first transmit power level may be variable. For example, during operation the program module further may dynamically select the second transmit power level when the power-state flag is selectively modified.

Additionally, the second transmit power level may reduce a net power consumption of the electronic device by reducing retries during the communication between the electronic device and the other electronic device.

In some embodiments, after selectively modifying the power-state flag, the program module monitors a set of trigger events and, when a trigger event is detected, repeats the selective modification of the power-state flag. For example, the set of trigger events may include: a change in the performance metric, and/or establishing a Bluetooth Low Energy connection with an additional electronic device.

Note that the communication protocol may include Bluetooth Low Energy.

Another embodiment provides a computer-program product for use with the receiving electronic device. This computer-program product includes instructions for at least some of the operations performed by the electronic device described previously.

Another embodiment provides an electronic device that includes: the antenna; and an interface circuit, coupled to the antenna, which communicates with the other electronic device using Bluetooth Low Energy. During operation, the interface circuit: transmits the packet to the other electronic device using the first transmit power level; and receives the feedback from the other electronic device about the communication, where the feedback includes the information specifying the performance metric associated with the communication. Then, the interface circuit: compares the performance metric to the threshold value; and selectively transitions from the low-power state to the high-power state based on the comparison, where the second transmit power level during the communication in the high-power state is larger than the first transmit power level during the communication in the low-power state.

Another embodiment provides the interface circuit described previously.

Another embodiment provides a method for selectively modifying an operating mode of an electronic device. During operation, the electronic device transmits the packet to the other electronic device during the advertising mode using the first transmit power level. Then, the electronic device receives the feedback from the other electronic device about the communication, where the feedback includes the information specifying the performance metric associated with the communication. The electronic device also compares the performance metric to the threshold value. Next, the electronic device selectively modifies the power-state flag based on the comparison, where the modification changes the power-state flag from the value associated with the low-power state to the value associated with the high-power state, and where the second transmit power level in the high-power state is larger than the first transmit power level in the low-power state. Furthermore, the electronic device selects the transmit power level used to transmit the subsequent packet based on the power-state flag.

The preceding summary is provided as an overview of some exemplary embodiments and to provide a basic understanding of aspects of the subject matter described herein. Accordingly, the above-described features are merely examples and should not be construed as narrowing the scope or spirit of the subject matter described herein in any way. Other features, aspects, and advantages of the subject matter described herein will become apparent from the following Detailed Description, Figures, and Claims.

### BRIEF DESCRIPTION OF THE FIGURES

FIG. 1 is a block diagram illustrating electronic devices wirelessly communicating in accordance with an embodiment of the present disclosure.

FIG. 2 is a flow diagram illustrating a method for selectively modifying an operating mode of one of the electronic devices in FIG. 1 in accordance with an embodiment of the present disclosure.

FIG. 3 is a flow diagram illustrating a method for selectively modifying an operating mode of one of the electronic devices in FIG. 1 in accordance with an embodiment of the present disclosure.

FIG. 4 is a drawing illustrating communication between the electronic devices of FIG. 1 in accordance with an embodiment of the present disclosure.

FIG. 5 is a block diagram illustrating one of the electronic devices of FIG. 1 in accordance with an embodiment of the present disclosure.

Note that like reference numerals refer to corresponding parts throughout the drawings. Moreover, multiple instances of the same part are designated by a common prefix separated from an instance number by a dash.

### DETAILED DESCRIPTION

In order to improve communication with another electronic device, during an advertising mode an electronic device (such as a smartphone) may transmit a packet with advertising information using a default transmit power level. Then, based on feedback about a performance metric associated with the communication from the other electronic device, the electronic device may selectively increase the transmit power level for a subsequent packet. Because this selective increase in the transmit power level may increase the overall power consumption, the change in the transmit power level may depend on a battery power level of the electronic device. However, the selective increase in the transmit power level may decrease the overall power consumption by reducing or eliminating retries. After selectively increasing the transmit power level, the electronic device may monitor a set of trigger events, such as a change in the performance metric or a connection being established. If one of the monitored trigger events occurs, the electronic device may selectively modify the transmit power level.

In these ways, the electronic device may improve the communication performance during the advertising mode. This capability may improve the user experience when using the electronic device.

In principle, the packets and the feedback may be transmitted and received by radios in the electronic devices in accordance with a wide variety of communication protocols. In the discussion that follows, a communication protocol compatible with Bluetooth™ (from the Bluetooth Special Interest Group of Kirkland, Wash.) is used as an illustration. In particular, Bluetooth Low Energy (BTLE) is used as an illustrative example.

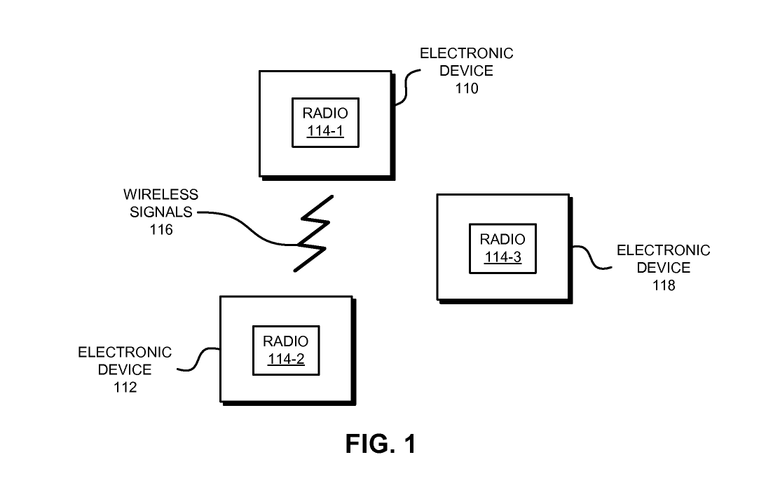

The communication between the electronic devices is shown in FIG. 1, which presents a block diagram illustrating electronic devices 110 and 112 wirelessly communicating. In particular, these electronic devices may wirelessly communicate while: transmitting packets with advertising information in wireless channels during an advertising mode, scanning for packets in the wireless channels during a scanner mode, establishing connections using an initiator mode, and/or transmitting and additionally receiving packets via a connection (which may additional information as payloads).

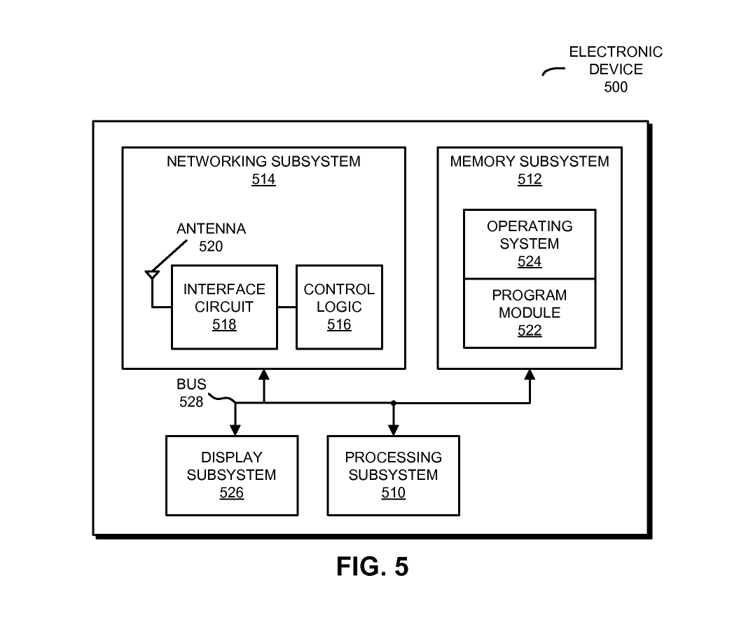

As described further below with reference to FIG. 5, electronic devices 110 and 112 may include subsystems, such as a networking subsystem, a memory subsystem and a processor subsystem. In addition, electronic devices 110 and 112 may include radios 114 in the networking subsystems. More generally, electronic devices 110 and 112 can include (or can be included within) any electronic devices with the networking subsystems that enable electronic devices 110 and 112 to wirelessly communicate with another electronic device. This can comprise transmitting packets with the advertising information on the wireless channels to enable electronic devices to make initial contact with or detect each other, followed by exchanging subsequent data/management frames to establish the connection, configure security options (e.g., IPSec), transmit and receive packets or frames via the connection, etc.

As can be seen in FIG. 1, wireless signals 116 (represented by a jagged line) are transmitted from a radio 114-1 in electronic device 110. These wireless signals 116 are received by radio 114-2 in electronic device 112. In particular, electronic device 110 (such as a smartphone) may broadcast or transmit packets with the advertising information at transmit times. In turn, electronic device 112 (such as a headset) may receive one or more of the packets, thereby detecting the presence of electronic device 110, by opening scan windows during the transmit times. This may subsequently allow electronic devices 110 and 112 to optionally establish a connection and communicate with each other.

Power consumption of electronic device 110 may be constrained. For example, electronic device 110 may include a portable electronic device with a battery (such as a rechargeable battery) having finite stored energy. Consequently, electronic device 110 may use BTLE to reduce power consumption during communication with electronic device 112. Typically, packets with advertising information are transmitted using a fixed transmit power level during the advertising mode in BTLE. However, this approach may result in degraded or poor communication with electronic device 112. In turn, the degraded or poor communication may result in retries (which increase the power consumption of electronic device 110) and/or a failure of electronic device 112 to detect electronic device 110.

To avoid these problems, electronic device 110 may selectively modify the transmit power level during the advertising mode. In particular, electronic device 110 may transmit a packet to electronic device 112 during the advertising mode using a first (default) transmit power level. Then, electronic device 110 may receive feedback from electronic device 112 about the communication. For example, the feedback may include information specifying a performance metric associated with the communication, such as: a mean-square error of an equalized signal relative to a target pattern, a bit error rate, a packet error rate, a received signal strength indicator, and/or another link quality metric. Next, electronic device 110 may selectively modify the transmit power level to a second (higher) transmit power level. This second transmit power level may improve the communication quality when a subsequent packet is transmitted to electronic device 112.

In general, operations in the communication technique may be performed by an interface circuit in the networking subsystem and/or the processing subsystem (i.e., in hardware and/or in software) in electronic device 110. For example, a program module executed by a processor in the processing subsystem may: compare the performance metric to a threshold value (such as a packet error rate of 30.8%); and may selectively modify a power-state flag based on the comparison (such as when the packet error rate exceeds the threshold value). This modification may change the power-state flag from a value associated with a low-power state to a value associated with a high-power state. Based on the power-state flag, the interface circuit may select the second transmit power level for use when transmitting the subsequent packet during the advertising mode.

Alternatively, fewer or more of the preceding operations may be performed by the interface circuit in electronic device 110. In some embodiments, all of the operations are performed by the interface circuit. For example, after receiving the feedback from electronic device 112, the interface circuit may compare the performance metric to a threshold value, and may selectively transition from the low-power state to the high-power state based on the comparison.

Note that a difference between the second transmit power level and the first transmit power level may be fixed. Alternatively, the difference between the second transmit power level and the first transmit power level may be variable. Thus, during operation the program module further may dynamically select the second transmit power level when the power-state flag is selectively modified.

Because the second (higher) transmit power level in the high-power state may increase the power consumption of electronic device 110, the selective modifying may be based on a battery power level. For example, the power-state flag may not be changed to the value associated with the high-power state if the battery power level is too low (such as less than another threshold value, e.g., 5 or 10% remaining charge). However, as noted previously, the use of the second transmit power level may reduce a net power consumption of electronic device 110 by reducing retries during the communication between electronic devices 110 and 112.

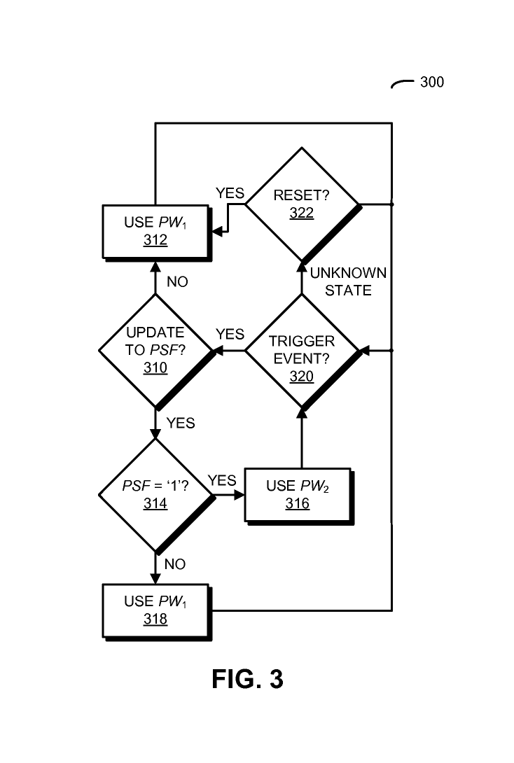

As described further below with reference to FIG. 3, after selectively modifying the power-state flag, the program module executed by the processor in electronic device 110 may monitor a set of trigger events and, when a trigger event is detected, may repeat the selective modification of the power-state flag. For example, the set of trigger events may include: a change in the performance metric, and/or establishing a Bluetooth Low Energy connection with an additional electronic device, such as electronic device 118.

In the described embodiments, processing a packet or frame in either of electronic devices 110 and 112 includes: receiving wireless signals 116 with the packet or frame; decoding/extracting the packet or frame from received wireless signals 116 to acquire the packet or frame; and processing the packet or frame to determine information contained in the packet or frame (such as the advertising information or additional information in the payload).

Although we describe the network environment shown in FIG. 1 as an example, in alternative embodiments, different numbers or types of electronic devices may be present. For example, some embodiments comprise more or fewer electronic devices. As another example, in another embodiment, different electronic devices are transmitting and/or receiving packets or frames.

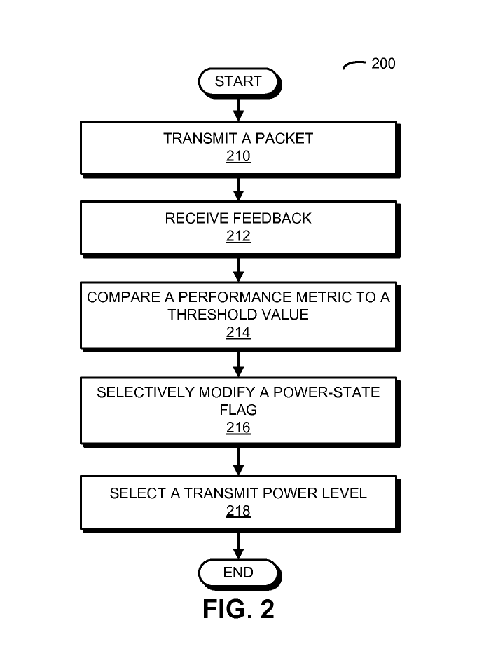

We now further describe embodiments of the communication technique. FIG. 2 presents a flow diagram illustrating method 200 for selectively modifying an operating mode of an electronic device, such as electronic device 110 in FIG. 1. During operation, the electronic device transmits a packet (operation 210) to another electronic device during an advertising mode using a first transmit power level. Then, the electronic device receives feedback (operation 212) from the other electronic device about the communication, where the feedback includes information specifying a performance metric associated with the communication. Moreover, the electronic device compares the performance metric to a threshold value (operation 214). Next, the electronic device selectively modifies a power-state flag (operation 216) based on the comparison, where the modification changes the power-state flag from a value associated with a low-power state to the value associated with a high-power state, and where a second transmit power level in the high-power state is larger than the first transmit power level in the low-power state. Furthermore, the electronic device selects a transmit power level (operation 218) used to transmit a subsequent packet based on the power-state flag.

In this way, the electronic device (for example, a program module, an interface circuit and/or a driver in the electronic device) may facilitate communication between the electronic device and another electronic device with improved communication quality. In particular, advertising packets may be communicated during an advertising mode with an improved performance metric associated with the communication. This may reduce retries and, thus, may improve a user experience when using the electronic device.

FIG. 3 presents a flow diagram illustrating method 300 for selectively modifying an operating mode of an electronic device (such as electronic device 110 in FIG. 1), which may be performed by a processor executing a program module and/or an interface circuit. If an update to the power-state flag (PSF) is not available (operation 310), the interface circuit defaults to the low-power state and uses the first (lower) transmit power level or PW₁ (operation 312). This default arrangement may ensure that the electronic device has longer battery life, especially if the electronic device spends most of the time in a sleep mode.

However, if an update to the power-state flag is available (operation 310), a determination is made as to whether the power-state flag equals ‘1’ (operation 314) or a value corresponding to the high-power state. Moreover, if the power-state flag equals ‘1’ (operation 314), the interface circuit transitions to the high-power state and uses the second (higher) transmit power level or PW₂ (operation 316). Otherwise, the interface circuit defaults to the low-power state and uses the first (lower) transmit power level (operation 318).

Then, the electronic device checks for a trigger event (operation 320), such as a BTLE connection being established with another electronic device, a change in the performance metric and/or another trigger event. If yes (operation 320), the electronic device checks for an update to the power-state flag (operation 310).

Note that, after operations 312, 316 and 318, the electronic device may perform operation 320. Furthermore, if hardware in the electronic device is in an unknown state, a reset may be asserted (operation 322) so that the interface circuit defaults to the low-power state and uses the first (lower) transmit power level (operation 312). Otherwise, the electronic device may continue to perform operation 320.

In an exemplary embodiment, instead of using a fixed transmit power level for BLTE, the electronic device adapts the transmit power level. While a fixed transmit power level can offer simplicity (e.g., by avoiding active control) for short distance (such as less than 10 m) communication and/or reduced power consumption, if communication (or link) performance is poor, connections may not be established and/or may be lost. Adapting the transmit power level may address these problems. This may improve a performance metric associated with the communication (and, thus, the link performance or link margin). For example, there may be an improved link margin between a cellular telephone and a headset (and, more generally, for a receiver down link). This approach may represent a reasonable compromise, because even though BTLE is intended to reduce power consumption in portable electronic devices, the transmit power level may be a small component of the total power consumption of the cellular telephone. In addition, the total power consumption may be improved because of fewer retries.

Thus, the electronic device may adapt or modify the transmit power level if one or more conditions for a higher transmit power level are met. For example, the one or more conditions may include: a packet error rate for the link that is greater than 30.8%; a bit error rate greater than 0.1%; a received signal strength indicator of less than −93 dBm; an indication that the link has poor margin or quality (such as the use of error-correction codes, e.g., a cyclic redundancy code, to recover information, or another performance metric exceeding or being less than a threshold value); and/or (country-dependent) regulatory constraints or requirements regarding the use of the second transmit power level. (Note that link margin may be defined as the difference between the transmit power level and the link sensitivity.) In some embodiments, a difference between the second transmit power level and the first transmit power level may be 7 dBm or 9.5 dBm.

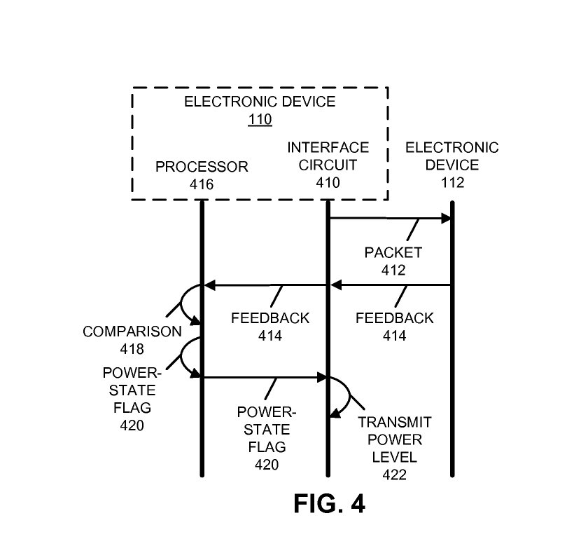

The communication technique is further illustrated in FIG. 4, which presents a drawing illustrating communication between electronic devices 110 and 112 (FIG. 1). In particular, interface circuit 410 in electronic device 110 may transmit packet 412 to electronic device 112 at a transmit time using a first transmit power level. In turn, electronic device 112 may receive packet 412 by scanning a wireless channel.

Then, electronic device 112 may communicate feedback 414 to interface circuit 410, which provides feedback 414 to processor 416. Processor 416 may execute a program module that: performs a comparison 418 of a performance metric included in feedback 414 and a threshold value; and selectively modifies a power-state flag 420 based on comparison 418, where the modification changes the power-state flag from a value associated with a low-power state to a value associated with a high-power state.

Next, processor 416 provides power-state flag 420 to interface circuit 410. In response, interface circuit 410 select a transmit power level 422 used to transmit a subsequent packet based on power-state flag 420. For example, a second transmit power level in the high-power state may be larger than the first transmit power level in the low-power state.

In some embodiments of methods 200 (FIG. 2) and 300, there may be additional or fewer operations. Moreover, the order of the operations may be changed, and/or two or more operations may be combined into a single operation.

We now describe embodiments of the electronic device. FIG. 5 presents a block diagram illustrating an electronic device 500, such as one of electronic devices 110 and 112 in FIG. 1. This electronic device includes processing subsystem 510, memory subsystem 512, and networking subsystem 514. Processing subsystem 510 includes one or more devices configured to perform computational operations. For example, processing subsystem 510 can include one or more microprocessors, application-specific integrated circuits (ASICs), microcontrollers, programmable-logic devices, and/or one or more digital signal processors (DSPs).

Memory subsystem 512 includes one or more devices for storing data and/or instructions for processing subsystem 510 and networking subsystem 514. For example, memory subsystem 512 can include dynamic random access memory (DRAM), static random access memory (SRAM), and/or other types of memory. In some embodiments, instructions for processing subsystem 510 in memory subsystem 512 include: one or more program modules or sets of instructions (such as program module 522 or operating system 524), which may be executed by processing subsystem 510. Note that the one or more computer programs may constitute a computer-program mechanism. Moreover, instructions in the various modules in memory subsystem 512 may be implemented in: a high-level procedural language, an object-oriented programming language, and/or in an assembly or machine language. Furthermore, the programming language may be compiled or interpreted, e.g., configurable or configured (which may be used interchangeably in this discussion), to be executed by processing subsystem 510.

In addition, memory subsystem 512 can include mechanisms for controlling access to the memory. In some embodiments, memory subsystem 512 includes a memory hierarchy that comprises one or more caches coupled to a memory in electronic device 500. In some of these embodiments, one or more of the caches is located in processing subsystem 510.

In some embodiments, memory subsystem 512 is coupled to one or more high-capacity mass-storage devices (not shown). For example, memory subsystem 512 can be coupled to a magnetic or optical drive, a solid-state drive, or another type of mass-storage device. In these embodiments, memory subsystem 512 can be used by electronic device 500 as fast-access storage for often-used data, while the mass-storage device is used to store less frequently used data.

Networking subsystem 514 includes one or more devices configured to couple to and communicate on a wired and/or wireless network (i.e., to perform network operations), including: control logic 516, an interface circuit 518 and an antenna 520. For example, networking subsystem 514 can include a Bluetooth™ networking system, a cellular networking system (e.g., a 3G/4G network such as UMTS, LTE, etc.), a universal serial bus (USB) networking system, a networking system based on the standards described in IEEE 802.11 (e.g., a Wi-Fi networking system), an Ethernet networking system, and/or another networking system.

Networking subsystem 514 includes processors, controllers, radios/antennas, sockets/plugs, and/or other devices used for coupling to, communicating on, and handling data and events for each supported networking system. Note that mechanisms used for coupling to, communicating on, and handling data and events on the network for each network system are sometimes collectively referred to as a ‘network interface’ for the network system. Moreover, in some embodiments a ‘network’ between the electronic devices does not yet exist. Therefore, electronic device 500 may use the mechanisms in networking subsystem 514 for performing simple wireless communication between the electronic devices, e.g., transmitting advertising packets or frames and/or scanning for advertising packets or frames transmitted by other electronic devices as described previously.

Within electronic device 500, processing subsystem 510, memory subsystem 512, and networking subsystem 514 are coupled together using bus 528. Bus 528 may include an electrical, optical, and/or electro-optical connection that the subsystems can use to communicate commands and data among one another. Although only one bus 528 is shown for clarity, different embodiments can include a different number or configuration of electrical, optical, and/or electro-optical connections among the subsystems.

In some embodiments, electronic device 500 includes a display subsystem 526 for displaying information on a display, which may include a display driver and the display, such as a liquid-crystal display, a multi-touch touchscreen, etc.

Electronic device 500 can be (or can be included in) any electronic device with at least one network interface. For example, electronic device 500 can be (or can be included in): a desktop computer, a laptop computer, a server, a media player (such as an MP3 player), an appliance, a subnotebook/netbook, a tablet computer, a smartphone, a cellular telephone, a piece of testing equipment, a network appliance, a set-top box, a personal digital assistant (PDA), a toy, a controller, a digital signal processor, a game console, a computational engine within an appliance, a consumer-electronic device, a portable computing device, a personal organizer, a sensor, a user-interface device and/or another electronic device.

Although specific components are used to describe electronic device 500, in alternative embodiments, different components and/or subsystems may be present in electronic device 500. For example, electronic device 500 may include one or more additional processing subsystems 510, memory subsystems 512, networking subsystems 514, and/or display subsystems 526. Additionally, one or more of the subsystems may not be present in electronic device 500. Moreover, in some embodiments, electronic device 500 may include one or more additional subsystems that are not shown in FIG. 5. For example, electronic device 500 can include, but is not limited to, a data collection subsystem, an audio and/or video subsystem, an alarm subsystem, a media processing subsystem, and/or an input/output (I/O) subsystem. Also, although separate subsystems are shown in FIG. 5, in some embodiments, some or all of a given subsystem or component can be integrated into one or more of the other subsystems or component(s) in electronic device 500. For example, in some embodiments program module 522 is included in operating system 524.

Moreover, the circuits and components in electronic device 500 may be implemented using any combination of analog and/or digital circuitry, including: bipolar, PMOS and/or NMOS gates or transistors. Furthermore, signals in these embodiments may include digital signals that have approximately discrete values and/or analog signals that have continuous values. Additionally, components and circuits may be single-ended or differential, and power supplies may be unipolar or bipolar.

An integrated circuit may implement some or all of the functionality of networking subsystem 514, such as a radio. Moreover, the integrated circuit may include hardware and/or software mechanisms that are used for transmitting wireless signals from electronic device 500 and receiving signals at electronic device 500 from other electronic devices. Aside from the mechanisms herein described, radios are generally known in the art and hence are not described in detail. In general, networking subsystem 514 and/or the integrated circuit can include any number of radios. Note that the radios in multiple-radio embodiments function in a similar way to the described single-radio embodiments.

In some embodiments, networking subsystem 514 and/or the integrated circuit include a configuration mechanism (such as one or more hardware and/or software mechanisms) that configures the radio(s) to transmit and/or receive on a given communication channel (e.g., a given carrier frequency). For example, in some embodiments, the configuration mechanism can be used to switch the radio from monitoring and/or transmitting on a given communication channel to monitoring and/or transmitting on a different communication channel. (Note that ‘monitoring’ as used herein comprises receiving signals from other electronic devices and possibly performing one or more processing operations on the received signals, e.g., determining if the received signal comprises an advertising packet or frame, etc.)

While a communication protocol compatible with the Bluetooth™ Low Energy standard was used as an illustrative example, the described embodiments of the communication techniques may be used in a variety of network interfaces. Furthermore, while some of the operations in the preceding embodiments were implemented in hardware or software, in general the operations in the preceding embodiments can be implemented in a wide variety of configurations and architectures. Therefore, some or all of the operations in the preceding embodiments may be performed in hardware, in software or both. For example, at least some of the operations in the communication technique may be implemented using program module 522, operating system 524 (such as a driver for interface circuit 518) or in firmware in interface circuit 518. Alternatively or additionally, at least some of the operations in the communication technique may be implemented in a physical layer, such as hardware in interface circuit 518.

While the preceding embodiments illustrated the communication technique using the advertising mode as an example, in other embodiments the communication technique is used during communication in other operating modes.

In the preceding description, we refer to ‘some embodiments.’ Note that ‘some embodiments’ describes a subset of all of the possible embodiments, but does not always specify the same subset of embodiments.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

1. An electronic device, comprising:
an antenna;
an interface circuit, coupled to the antenna, configured to communicate with another electronic device using a communication protocol, wherein the interface circuit is configured to:
transmit a packet to the other electronic device during an advertising mode using a first transmit power level;
receive feedback from the other electronic device about the communication, wherein the feedback includes information specifying a performance metric associated with the communication; and
select a transmit power level used to transmit a subsequent packet based on a power-state flag;
a processor; and
memory, wherein the memory stores a program module, and wherein the program module is configured to be executed by the processor to improve communication quality, the program module including:
instructions for comparing the performance metric to a threshold value; and
instructions for selectively modifying the power-state flag based on the comparison, wherein the modifying changes the power-state flag from a value associated with a low-power state to a value associated with a high-power state; and
wherein a second transmit power level in the high-power state is larger than the first transmit power level in the low-power state.

2. The electronic device of claim 1, wherein the performance metric includes one of: a bit error rate, a packet error rate, a received signal strength indicator, and another link quality metric.

3. The electronic device of claim 1, wherein the selective modifying is further based on a battery power level.

4. The electronic device of claim 1, wherein a difference between the second transmit power level and the first transmit power level is fixed.

5. The electronic device of claim 1, wherein a difference between the second transmit power level and the first transmit power level is variable.

6. The electronic device of claim 5, wherein the program module further includes instructions for dynamically selecting the second transmit power level when the power-state flag is selectively modified.

7. The electronic device of claim 1, wherein the second transmit power level reduces a net power consumption of the electronic device by reducing retries during the communication between the electronic device and the other electronic device.

8. The electronic device of claim 1, wherein the program module further includes, after the instructions for selectively modifying the power-state flag, instructions for monitoring a set of trigger events and, when a trigger event is detected, repeats the instructions for selectively modifying the power-state flag.

9. The electronic device of claim 8, wherein the set of trigger events includes one or more of: a change in the performance metric, and establishing a Bluetooth Low Energy connection with an additional electronic device.

10. The electronic device of claim 1, wherein the communication protocol includes Bluetooth Low Energy.

11. An electronic device, comprising:
an antenna; and
an interface circuit, coupled to the antenna, configured to communicate with another electronic device using Bluetooth Low Energy, wherein the interface circuit is configured to:
transmit a packet to the other electronic device using a first transmit power level;
receive feedback from the other electronic device about the communication, wherein the feedback includes information specifying a performance metric associated with the communication;
compare the performance metric to a threshold value; and
selectively transition from a low-power state to a high-power state based on the comparison, wherein a second transmit power level during the communication in the high-power state is larger than the first transmit power level during the communication in the low-power state.

12. The electronic device of claim 11, wherein the performance metric includes one of: a bit error rate, a packet error rate, a received signal strength indicator, and another link quality metric.

13. The electronic device of claim 11, wherein the selective transitioning is further based on a battery power level.

14. The electronic device of claim 11, wherein a difference between the second transmit power level and the first transmit power level is fixed.

15. The electronic device of claim 11, wherein a difference between the second transmit power level and the first transmit power level is variable.

16. The electronic device of claim 15, wherein the interface circuit is further configured to dynamically select the second transmit power level.

17. The electronic device of claim 11, wherein the second transmit power level reduces a net power consumption of the electronic device by reducing retries during the communication between the electronic device and the other electronic device.

18. The electronic device of claim 11, wherein, after the selective transitioning, the interface circuit is further configured to monitor a set of trigger events and, when a trigger event is detected, repeats the selective transitioning.

19. The electronic device of claim 18, wherein the set of trigger events includes one or more of: a change in the performance metric, and establishing a Bluetooth Low Energy connection with an additional electronic device.

20. A method for selectively modifying an operating mode of an electronic device, wherein the method comprises:
transmitting a packet to another electronic device during an advertising mode using a first transmit power level;
receiving feedback from the other electronic device about the communication, wherein the feedback includes information specifying a performance metric associated with the communication;
comparing the performance metric to a threshold value;
selectively modifying a power-state flag based on the comparison, wherein the modifying changes the power-state flag from a value associated with a low-power state to a value associated with a high-power state; and wherein a second transmit power level in the high-power state is larger than the first transmit power level in the low-power state; and
selecting a transmit power level used to transmit a subsequent packet based on the power-state flag.
